(19) United States
(12) Patent Application Publication
(10) Pub. No.: US 2014/0345401 A1
(43) Pub. Date: Nov. 27, 2014

(54) FAST MOVEMENT OF PRINTING PRESS COMPONENTS WITH FINE ADJUSTMENT AND ZERO BACKLASH

(71) Applicant: SERVOTEC GMBH HERBERT BAUCH, Langenfeld (DE)

(72) Inventor: Herbert Bauch, Burscheid (DE)

(21) Appl. No.: 14/354,791

(22) PCT Filed: Jan. 16, 2013
(86) PCT No.: PCT/DE2013/000020

§ 371 Date: Jul. 17, 2014

(30) Foreign Application Priority Data
Jan. 18, 2012 (DE) 10 2012 000 752.3

(51) Int. Cl. F16H 25/20

(52) U.S. Cl. CPC F16H 25/2003
USPC 74/89.29

(57) ABSTRACT

The invention relates to the fast movement of printing press components with integrated fine adjustment, in particular in flexographic printing presses, characterised in that the distances in particular between the printing press components impression roller (43), printing roller (44), and anilox roller (45) are determined by means of spindles (10) that have at least two aligned threaded sections of slightly different pitch comprising a pitch part A (11) and a pitch part B (12) in which at least one nut A (20) and nut B (21) having a corresponding pitch engage, wherein at least one of the nuts (20, 21) is integrated into the base parts comprising basic frame (40), carriage (41) or bearing block (42) and fixed either on the spindle (10) or in the bearing seat.

The invention relates to a printing press, particularly a flexographic printing press in which the print roller is pressed against or pulled from the counter-pressure roller, and the screen roller is pressed against or pulled from the print roller and the ink roller is pressed against or pulled from the screen roller. At the same time, a wear-independent zero-backlash state between the spindle and the nut is preferred. Quick adjustment is always sought when greater clearances must be quickly bridged, such as for format changes or when the printing function is on or off. Fine adjustment is helpful when exact and even pressure is to be set.

Published application DE 10242009 comes closest to the proposed solutions for quick adjustment. It describes a printing machine in which for quick adjustment various spindles are coupled to shafts and provide various gear ratios.

Disadvantages of the existing solutions for quick adjustment are additional actuating, force transfer, bearing, and coupling elements. In addition, no sufficient precise predetermining of individual formats and no simultaneous automatic and manual operation are possible. The required space and the construction costs of the known solutions for additional quick adjustment are also very substantial. The necessary special adaptation to circumstances, in other words the lack of universality, is another shortcoming of the known solutions.

### OBJECT

For that reason, the object of the invention is to find a universal solution with minimal construction costs and the least amount of required space, that can be manually driven or motor-driven, and at the same time is very rigid and not sensitive to external influences such as dirt.

The object is attained as follows according to the invention as in claim 1 and the following. The invention is a quick-adjustment device of printing press components to each other with an integrated fine adjustment for the exact positioning of each position as well as the optional zero-backlash state of each force transfer circuit. To save on space and components, the fine and quick-adjustment devices are located on a spindle. The precise fine adjustment of the printing press components while exposed simultaneously to high-stress loading preferably results by typical is drive train threads such as trapeze or ball screw spindles or a combination of various threads. Critical are low friction loss and the possibility of zero backlash in the direction of movement. To be able to implement a quick adjustment by means of threads, a large pitch and thus generally an appropriate diameter are necessary. A large spindle diameter is also necessary for the transfer of high forces and a solid construction. For especially large pitches, multiple screwthreads are provided. To execute the fine adjustment, they are on a threaded spindle that can optionally also consist of multiple parts, at least two different pitch sections into which nuts with a corresponding identical pitch engage. For the fine adjustment, one turns the threaded spindle, or synchronously nuts A and B. The distance change of the nuts to each other corresponds per rotation only to the pitch difference between pitch parts A and B. This applies in both movement directions. Of these systems, several may be stacked on top of each other, as well as nested in each other or they may be coupled to each other rigidly, in a force-dependent manner, in an elastic manner, and/or detachably. For eliminating backlash, it is proposed to use, between nuts A and B or the components force-limited by the actuators, such as springs, cylinders, and so on. In addition, it is proposed to eliminate backlash by bracing the nuts against each other in a slotted or divided and elastic manner. Zero backlash is then also maintained in the event of wear and heat expansion.

### EMBODIMENT

An exemplary embodiment is further explained below by means of drawings.

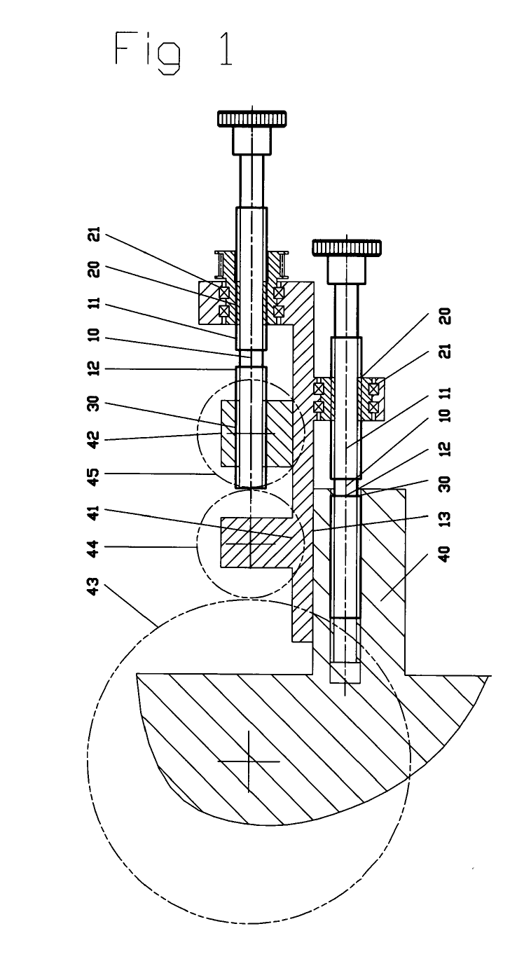

FIG. 1 is a side view of a section of a printing press consisting of a base frame with a counter-pressure roller, slide with a print roller, and bearing block with a screen roller.

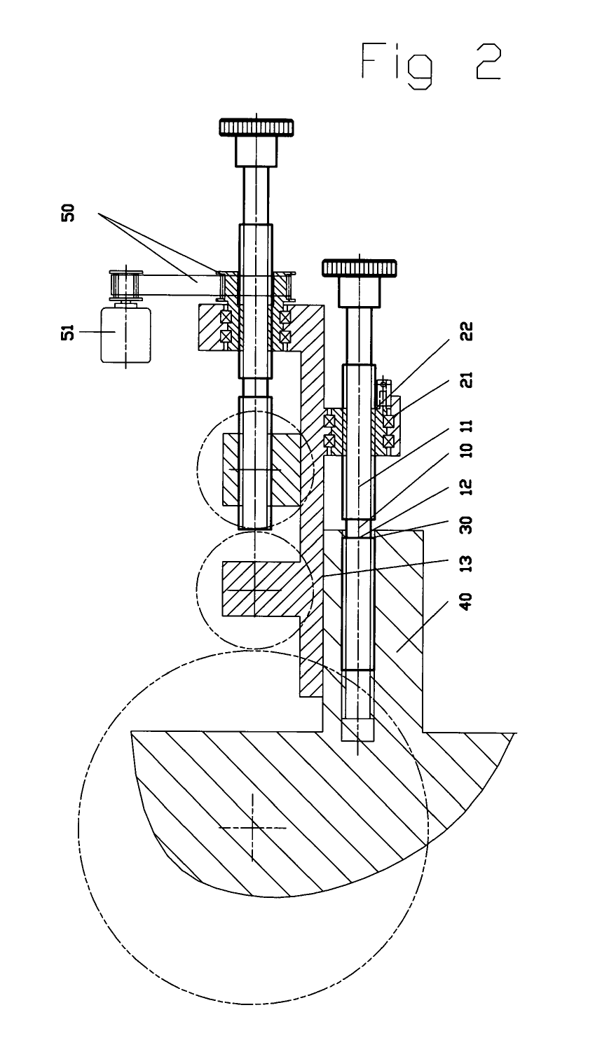

FIG. 2 is like FIG. 1 a side view of a section of a printing press with an actuator for quick adjustment and a sample embodiment of nut clamping.

The views show the particular type of quick-adjustment device or quick displacement and alternatively the exact fine adjustment of the print roller relative to the counter-pressure roller and the screen roller relative to the counter-pressure roller, for example for format changes. In the same way, additional components or rollers can be positioned, such as the ink roller to the screen roller. The rollers are driven together or individually. Between the base frame, the slide, and the bearing blocks, there are guides that absorb the transverse forces and torques and impose an exact movement direction. The guides are equipped with clamping or fixing elements so that the base frame can be interconnected to the slide and bearing blocks in a force- and/or form-locking manner. For the exact repetition of positions, stops can be set near the guides.

For a stable connection between the rollers and for good force transfer, thick spindles with correspondingly large threads and consequently large pitches are proposed. The large pitch means that a large distance can be covered with few rotations, which means a very fast adjustment of the distances.

This quick adjustment takes place when the spindle with pitch part B rotates in nut B and nut A seated in the slide rotates in the slide and is firmly seated on a pitch part A of the spindle. The firm seating on the spindle results for example from spreading of the slotted nut by means of the machine element. With each rotation of the spindle, or of the nut B, the distance between counter-pressure roller and print roller is changed corresponding to a step of 4 mm for example. For the fine adjustment, the nut A is no longer firmly seated on the pitch part A of the spindle, but in the slide. This occurs for example by actuating the same machine element oppositely as for clamping on the spindle by which the machine element seated in the nut no longer acts on the spindle but on the slide. Now, the spindle moves both in the nut A as well as in the nut B. The distance change between the counter-pressure roller and the print roller thus amounts only to the difference of the pitch parts A and B, in other words for example only 0.1 mm per rotation.

One can also proceed similarly for all other components of the printing press that have a relatively variable position allocation.

Should quick adjustment occur centrally for example for a format change, and should the fine adjustment occur manually, then for example all of the nuts A or B for adjusting the print rollers and the screen rollers are interconnected by drive elements, such as articulated shafts, belts, chain gear wheels. The manually driven or motor-driven torque introduced at a location is sufficient to create the format-dependent distances between the counter-pressure roller, the print roller, and the screen roller of an inking unit or an entire printing tower.

There are many additional possible drive combinations depending on where the larger pitch is, whether the spindle or both nuts are driven, or one spindle with a nut is driven.

The zero-backlash state between a nut and the spindle as well as between nuts and a base element, slide, and bearing block results for example by dividing the nut. At the radial dividing point for example, the nut has ramps running across the angle of rotation, with for example the same pitch as the thread, which change, with the angle of rotation, the distance of the nut parts. One part of the nut is secured against rotation, while the other part can rotate and is engaged by the friction torque or spring torque until zero backlash exists between the housing walls and the thread turns. Backward movement in a reverse direction of rotation is prevented by a fine grating on the ramps or a commercially available backstop in the form of an eccentric roll body.

List of reference characters:

10 = spindle
11 = pitch part A
12 = pitch part B
13 = bearing
20 = nut A
21 = bearing
22 = clamping element
30 = nut B
40 = base frame
41 = slide
42 = bearing block
43 = counter-pressure roller
44 = print roller
45 = screen roller
50 = drive elements
51 = actuator

1. A quick-adjustment device for printing press components with an integrated fine adjustment in flexographic printing presses, wherein distances between the printing press components, namely the counter-pressure roller, print roller, and screen roller, are determined by spindles that have at least two identically oriented thread sections that differ slightly in pitch and have a pitch section A and a pitch section B, on which is engaged at least a nut A and nut B with corresponding pitches, at least one of the nuts being integrated in the base parts, namely the base frame, slide or bearing block and optionally firmly seated on the spindle or in the bearing seat.

2. The quick-adjustment device of printing press components with an integrated fine adjustment in flexographic printing presses according to claim 1, wherein the nuts A and/or B are slotted and the slotted region is in contact with a machine element or actuator in an elastic or tensioned manner.

3. The quick-adjustment device of printing press components with an integrated fine adjustment in flexographic printing presses according to claim 1, wherein the nuts A that are axially firmly anchored in the base parts are separate and the relatively moveable nut parts are in contact via springs and/or machine elements and/or actuators.

4. The quick-adjustment device of printing press components with an integrated fine adjustment in flexographic printing presses according to claim 1, wherein spring elements or force generation elements are s used between the force-transferring components of the nuts A and B.

5. The quick-adjustment device of printing press components with an integrated fine adjustment in flexographic printing presses according to claim 1, wherein all of the nuts A or B of a printing press are connected to a drive train in a rotationally form-locking manner and the drive train is manually driven and/or motor-driven and is fixed and has a positioning device.

6. The quick-adjustment device of printing press components with an integrated fine adjustment in flexographic printing presses according to claim 1, wherein all of the spindles of a printing press or printing tower can be coupled to and uncoupled from a rotary drive train, and the nuts rotatable as an option on the spindle or opposite their base parts, particularly the base frame, slide, bearing block, are clamped.

7. The quick-adjustment device of printing press components with an integrated fine adjustment in flexographic printing presses according to claim 1, wherein all of the rotatable nuts A or B of a printing press or a printing tower are connected by drive elements to a motorized actuator and have an automatic switchover of the clamping element in contact with the nut A or nut B between the spindles and the base parts, accommodating rotatable nuts, such as the base frame, slide, bearing block, wherein in doing so, each spindle can be individually driven in a manual manner.

8. The quick-adjustment device of printing press components with an integrated fine adjustment in flexographic printing presses according to claim 1, wherein spindles are constructed with at least a pitch section A and a pitch section B on both pitch parts with left pitches or with right pitches in a mono-gear or multi-gear setup, wherein regardless of the pitch section, various types of threads are provided.

9. The quick-adjustment device of printing press components with an integrated fine adjustment in flexographic printing presses according to claim 1, wherein for zero backlash between the nut and spindle as well as between the nut and base parts, such as base frame, slide, and bearing block, the nut is radially divided and at the dividing points has multiple ramps running across the angle of rotation with preferably the same pitch as the spindle, wherein one part of to the nut is secured against rotation, while the other, by means of the friction torque between the rotating spindle and the nut), optionally rotates an additional spring, and backward travel of the nut is prevented by fine ribs, oriented in the pitch direction, on the ramps.
